(19) United States
(12) Patent Application Publication
(10) Pub. No.: US 2005/0045622 A1
(43) Pub. Date: Mar. 3, 2005

(54) Structure of a fragrant essence burner

(76) Inventor: Chao-Wel Huang, Shindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/646,813

(22) Filed: Aug. 25, 2003

(51) Int. Cl. H05B 1/02

(52) U.S. Cl. 219/497; 392/394

(57) ABSTRACT

An improved structure of a fragrant essence burner is composed of furnace body and electric heat device; particularly, resistance detection element is set in the bottom wall of the container of furnace body for detecting the presence of water in the container to control power source of the electric heat element.

### BACKGROUND OF THE INVENTION

1. Field of the Invention

The present invention relates to an improved structure of a fragrant essence burner; particularly, resistance detection element is set in water of the container of a fragrant essence burner. By different resistance rates in water and air, when a fragrant essence burner is without water, resistance detection element is used to control turning off power source of electric heat element automatically for safety purpose.

2. Prior Art

Referring to a fragrant essence burner, it heats and disintegrates fragrant essence dropped into water of the container to release ion, phytoncide, from the essence into indoor air and let people in the room enjoy forest bath as if they were in a forest. However, there are two kinds of heating structures of fragrant essence burners used habitually. One is using candle to heat but the container will be broken easily when the candle is close to it burning; in addition, intermediate burning of the candle makes water temperature decrease gradually that influences the evaporation of the essence. The other is using electricity to heat; although it can maintain water temperature consistent, the user must always pay attention to the amount of water in the container. If a burner continues heating without water, the container may be broken and even cause disaster.

### OBJECTS OF THE INVENTION

The primary purpose of the present invention is to solve said loss of a fragrant essence and provide an improved structure that is setting the resistance detection element in the bottom wall of the container of a fragrant essence burner. By different resistance rates when the resistance detection element is in water and air, it will drive power source of the electric heat element to heat when water is in the container or turn off power source of the electric heat element when the container is without water.

### BRIEF DESCRIPTION OF DRAWINGS

FIG. 1 is a schematic view of this embodiment of the present invention containing a local sectional view.

FIG. 2 is a circuit block chart of an electric heat device of the present invention.

FIG. 3 is a circuit diagram of an electric heat device of this embodiment.

### DESCRIPTION OF THE REFERRED EMBODIMENT

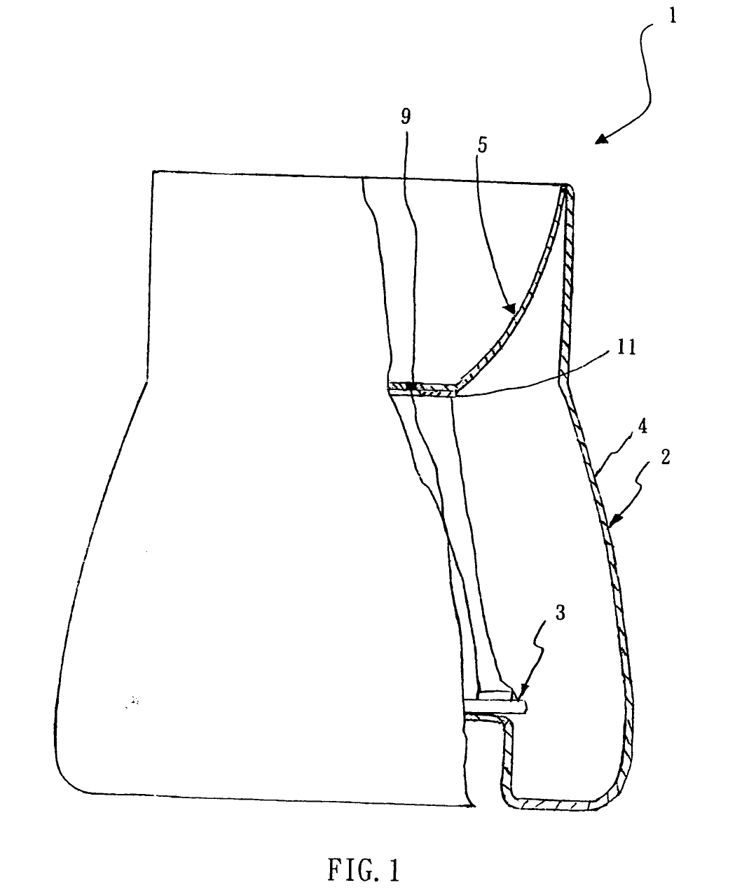

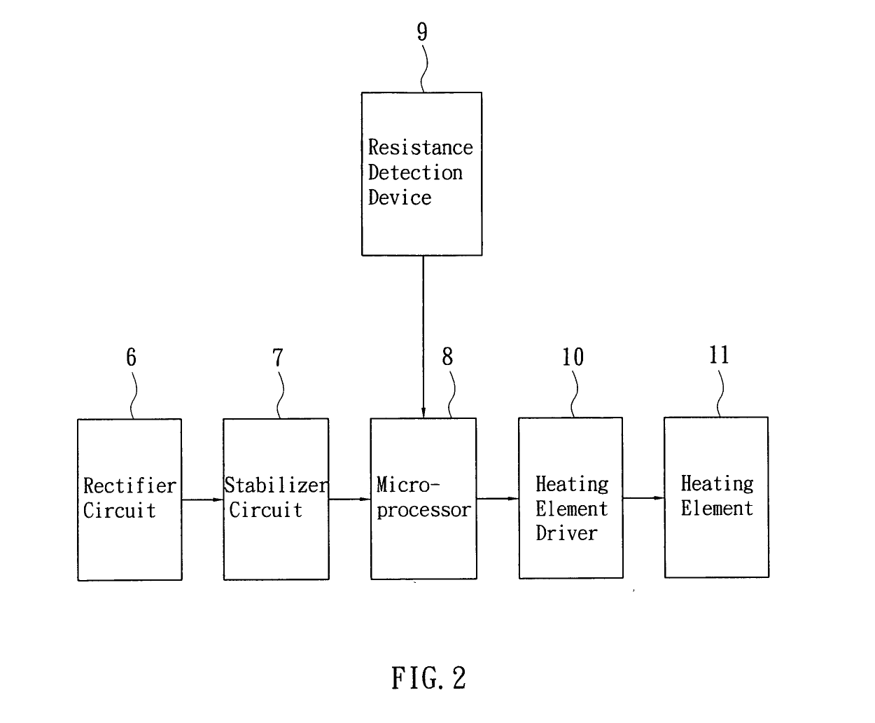

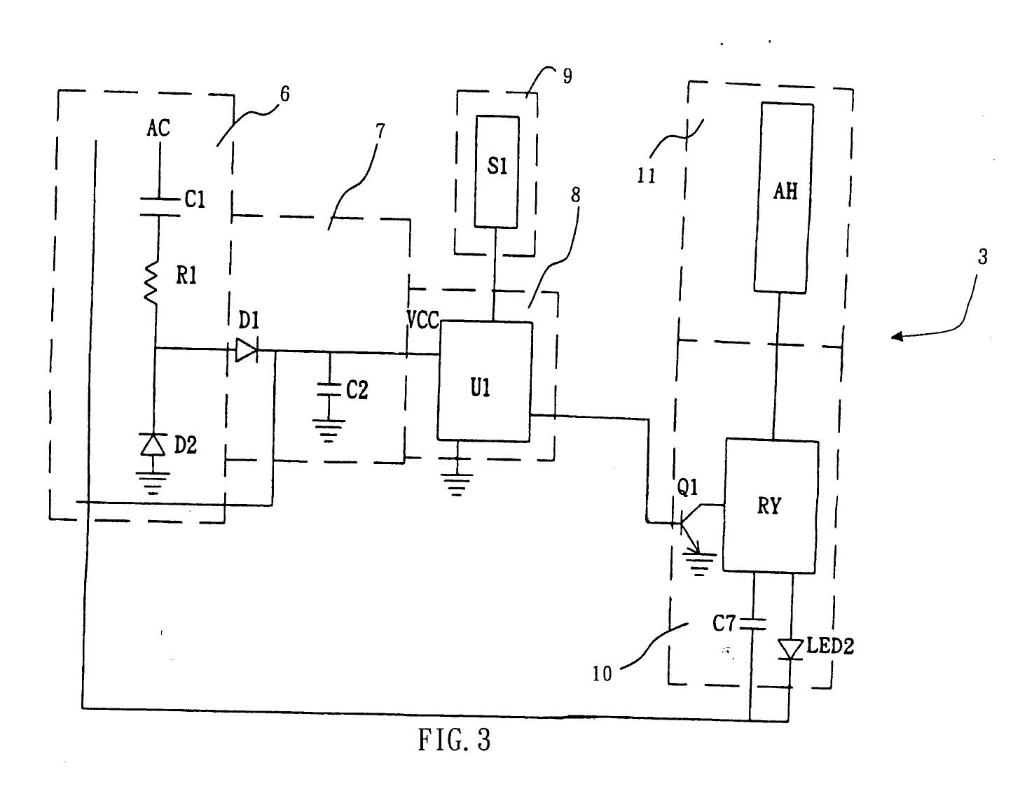

Referring to FIG. 1, FIG. 2 and FIG. 3, a fragrant essence burner (1) of the present invention is composed of furnace body (2) and electric heat device (3). Within furnace body (2) is formed of cover base (4) and a container (5) to be a whole. The cover base (4) is a hollow shell and its appearance can be into various proper shapes; in addition, its surface also can be with various decorative patterns and inner part is used to contain circuit plate and electric heat element (11) of an electric heat device (3). The container (5) has an opening at its top and a resistance device (9) connects with a microprocessor (8) in the cover base (4) set in the bottom wall of the container (5) to turn off power source of the electric heat element (11) when the container is without water.

As showing in FIG. 1, FIG. 2 and FIG. 3, an electric heat device (3) comprises a rectifier circuit (6), a voltage stabilizer circuit (7), the microprocessor (8), a resistance detection device (9), an electric heat element driven circuit (10) and the electric heat element (11). Within, alternating current drops via the rectifier circuit (6) to generate direct current; stabilizer circuit (7) is inputted for filtration and voltage stabilization to create the voltage to be used by the microprocessor (8) and a resistance detection device (9). The microprocessor (8) is preset for a given range of resistance rate of contacting with water. Once a resistance detection device (9) detects the output of resistance rate signal when it connects with water, the microprocessor (8) will output a control signal to start the electric heat element (11) through an electric heat element driven circuit (10) heating water in the container (5) for the fragrant essence to release phytoncide into air so as to achieve the effect of heating. On the other hand, if the container (5) is without water or a resistance detection device (9) detects the output of resistance rate signal when it contacts with air, the microprocessor (8) has no signal to output and achieve the effect of turning off power source of the electric heat element (11) for safety.

1. An improved structure of a fragrant essence burner, comprising:
furnace body is formed of cover base and a container to be a whole; said cover base is a hollow shell and said container has an opening at ots top; an electric heat device is combined in said cover base and the container is used to contain water and the fragrant essence;
an electric heat device which is alternating current drops via the rectifier circuit to generate direct current; stabilizer circuit is imputed for filtration and voltage stabilization to create the voltage to be used by the microprocessor and a resistance detection device; said microprocessor is preset for a given range of resistance rate of contacting with water; once said resistance detection element detects the output of resistance rate signal when it contacts with water or it doesn't contact with water, the microprocessor will output a control signal or won't output signal so as to achieve the control of power source of the electric heat element.

2. An improved structure of a fragrant essence burner according to claim 1, wherein said the resistance detection element is set in the bottom wall of the container of said furnace body to detect the presence of water in the container so as to achieve the control of power source of the electric heat element.

3. An improved structure of a fragrant essence according to claim 1, wherein said the appearance of cover base of the furnace body can be into various proper shapes and the surface also can be with various decorative patterns.
